(19) United States
(12) Patent Application Publication
(10) Pub. No.: US 2025/0378500 A1
(43) Pub. Date: Dec. 11, 2025

(54) SYSTEM AND METHOD FOR PROVIDING CONTENT BASED ASSESSMENTS

(71) Applicant: JPMorgan Chase Bank, N.A., New York, NY (US)

(72) Inventor: Ramesh VANGALA, Hyderabad (IN)

(73) Assignee: JPMorgan Chase Bank, N.A., New York, NY (US)

(21) Appl. No.: 19/233,752

(22) Filed: Jun. 10, 2025

(30) Foreign Application Priority Data
Jun. 11, 2024 (IN) 202411045016

(51) Int. Cl. G06Q 40/06; G06Q 50/08; G06Q 50/16

(52) U.S. Cl. CPC G06Q 40/06; G06Q 50/08; G06Q 50/165

(57) ABSTRACT

A system and method for providing content-based assessments are disclosed. The method includes receiving a request from a user device to initiate a process for at least one property. Further, the method includes obtaining a plurality of media items captured from a construction site of the at least one property at predefined time intervals. Further, the method includes loading the media items into a trained model for performing an analysis, the analysis includes comparing the media items with a set of input data corresponding to a virtual representation of the property. Further, the method includes generating a first report and a second report related to a construction progress and a construction quality, and a third report based on the first report and the second report. Thereafter, the method includes transmitting a recommendation based on the third report, to a device to process the request.

### CROSS-REFERENCE TO RELATED APPLICATIONS

This application claims priority benefit from Indian Application No. 202411045016, filed on Jun. 11, 2024, in the India Patent Office, which is hereby incorporated by reference in its entirety.

### FIELD OF THE DISCLOSURE

This technology generally relates to the technical field of information processing, and more particularly relates to methods and systems for providing content-based assessments using a technological improvement to machine learning techniques.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Due to rapid development in technology, internet finance has emerged as a necessity for various business sectors and individuals. It serves diverse purposes such as purchasing movable or fixed assets (e.g., home or property). Internet finance represents a revolutionary financial business model where both online enterprises and traditional financial institutions utilize information communication technology and the internet to realize fund integration, loan distributions, payment, investment, and information intermediary services.

The introduction of internet finance and mortgage-backed security has made the dream of owning a property (such as a home) possible for a much larger number of individuals. When it comes to purchasing a home, many individuals rely on loans to make their dream of own a home a reality. The loan processing for homes involves a series of steps, starting with the application process where potential buyers submit their financial information and details about a property they wish to purchase. Lenders then review the application, assess the borrower's creditworthiness, and determine the loan amount (or loan value) and terms. Loan processing to purchase a property is a key step for individuals as it enables them to achieve the goal of owning property in their name.

Currently, loan processing for a property and estimating valuation for the property is a tedious and time-consuming process. It requires a meticulous process and diligent checks of various information associated with a borrower. Loan disbursement for the development of a new property or purchase of property necessitates a site visit to manually evaluate the property and to manually check progress before releasing money or disbursements from the lenders or loan providers. Because of the manual nature of loan processing, it lacks systematic evidence and analysis remains largely unregulated. Further, manual loan processing is also prone to bias toward the builder or property owner by the agent. Additionally, the absence of tracking construction or development progress during disbursement may result in substantial financial losses, increased risk of default, and failure to recover funds, potentially leading to more non-performing assets (NPA). Thus, in the process of loan processing and disbursement, property evaluations are completely based on the agent or evaluator's decision which could lead to high risk to the lender (for example, banks).

Hence, in view of these and other existing limitations, there arises an imperative need to provide an efficient technological improvement to overcome the above-mentioned limitations and to provide a method and system to provide accurate assessments for loan disbursements.

### SUMMARY

The present disclosure, through one or more of its various aspects, embodiments, and/or specific features or sub-components, provides, inter alia, various systems, servers, devices, methods, media, programs, and platforms for providing content based assessments.

According to an aspect of the present disclosure, a method for providing content-based assessments is disclosed. The method is implemented by at least one processor. The method includes receiving, by the at least one processor, a request from a user device to initiate a process for at least one property. The method further includes obtaining, by the at least one processor, a plurality of media items captured from a construction site of the at least one property at predefined time intervals, in response to the request. The method further includes loading, by the at least one processor, the plurality of media items into a trained model for performing an analysis on the plurality of media items, the analysis includes comparing the plurality of media items with a set of input data corresponding to a virtual representation of the at least one property. The method further includes generating, by the at least one processor, a first report related to a construction progress and a second report related to a construction quality of the at least one property based on the analysis on the plurality of media items. The method further includes generating, by the at least one processor, a third report of the at least one property based on the first report and the second report. The method further includes transmitting, by the at least one processor, at least one recommendation based on the third report, for processing the request.

In accordance with an exemplary embodiment, the plurality of media items includes images, videos, and construction site surroundings of the at least one property.

In accordance with an exemplary embodiment, the set of input data includes a project schedule associated with the construction site of the at least one property, building information model, video(s) of surroundings of the construction site, a blueprint, and a predefined construction quality of the at least one property.

In accordance with an exemplary embodiment, the predefined time intervals include a first interval and subsequent intervals.

In accordance with an exemplary embodiment, the analysis on the plurality of media items at the subsequent intervals includes the steps of comparing, by the at least one processor, the plurality of media items captured at the subsequent intervals with the set of input data to determine a delay in the construction progress of the at least one property; and updating, by the at least one processor, the delay in the construction progress of the at least one property in the first report.

In accordance with an exemplary embodiment, the trained model is developed using machine learning (ML).

In accordance with an exemplary embodiment, the third report includes a ratio, quality deviations within allowed thresholds as per design, progress as per deadlines, and location of the at least one property.

In accordance with an exemplary embodiment, the first report includes new changes identified compared to a previous report, deviations identified compared to a project plan, projected completion date, and remaining construction work of the at least one property.

In accordance with an exemplary embodiment, the second report includes information related to construction materials, dimensions of an interior of the at least one property, shapes of structures, and types of equipment used for construction of the at least one property.

According to another aspect of the present disclosure, a computing device configured to implement an execution of a method for providing content-based assessments is disclosed. The computing device includes a processor; a memory; and a communication interface coupled to each of the processor and the memory. The processor may be configured to receive a request from a user device to initiate a process for at least one property; obtain a plurality of media items captured from a construction site of the at least one property at predefined time intervals, in response to the request; load the plurality of media items into a trained model to perform an analysis on the plurality of media items, the analysis includes a comparison of the plurality of media items with a set of input data corresponding to a virtual representation of the at least one property; generate a first report related to a construction progress and a second report related to a construction quality of the at least one property based on the analysis on the plurality of media items; generate a third report of the at least one property based on the first report and the second report; and transmit at least one recommendation related to at least one recommendation based on the third report, to a device to process the request

In accordance with an exemplary embodiment, the plurality of media items includes images, videos, and construction site surroundings of the at least one property.

In accordance with an exemplary embodiment, the set of input data includes a project schedule associated with the construction site of the at least one property, building information model, video(s) of surroundings of the construction site, a blueprint, and a predefined construction quality of the at least one property.

In accordance with an exemplary embodiment, the predefined time intervals include a first interval and subsequent intervals.

In accordance with an exemplary embodiment, to analyse the plurality of media items at the subsequent intervals, the processor may be configured to compare the plurality of media items captured at the subsequent intervals with the set of input data to determine a delay in the construction progress of the at least one property; and update the delay in the construction progress of the at least one property in the first report.

In accordance with an exemplary embodiment, the trained model is developed using machine learning (ML).

In accordance with an exemplary embodiment, the third report includes a ratio, quality deviations within allowed thresholds as per design, progress as per deadlines, and location of the at least one property.

In accordance with an exemplary embodiment, the first report includes new changes identified compared to a previous report, deviations identified compared to a project plan, projected completion date, and remaining construction work of the at least one property.

In accordance with an exemplary embodiment, the second report includes information related to construction materials, dimensions of an interior of the at least one property, shapes of structures, and types of equipment used for construction of the at least one property.

According to yet another aspect of the present disclosure, a non-transitory computer-readable storage medium storing instructions for providing content-based assessments is disclosed. The instructions include executable code which, when executed by a processor, may cause the processor to receive a request from a user device to initiate a process for at least one property; obtain a plurality of media items captured from a construction site of the at least one property at predefined time intervals, in response to the request; load the plurality of media items into a trained model to perform an analysis on the plurality of media items, the analysis includes a comparison of the plurality of media items with a set of input data corresponding to a virtual representation of the at least one property; generate a first report related to a construction progress and a second report related to a construction quality of the at least one property based on the analysis on the plurality of media items; generate a third report of the at least one property based on the first report and the second report; and transmit at least one recommendation based on the third report, for processing the request.

In accordance with an exemplary embodiment, the plurality of media items includes images, videos, and construction site surroundings of the at least one property.

In accordance with an exemplary embodiment, the set of input data includes a project schedule associated with the construction site of the at least one property, building information model, video(s) of surroundings of the construction site, a blueprint, and a predefined construction quality of the at least one property.

In accordance with an exemplary embodiment, the predefined time intervals include a first interval and subsequent intervals.

In accordance with an exemplary embodiment, to analyze the plurality of media items at the subsequent intervals, the executable code when executed causes the processor to compare the plurality of media items captured at the subsequent intervals with the set of input data to determine a delay in the construction progress of the at least one property; and update the delay in the construction progress of the at least one property in the first report.

In accordance with an exemplary embodiment, the trained model is developed using machine learning (ML).

In accordance with an exemplary embodiment, the third report includes a ratio, quality deviations within allowed thresholds as per design, progress as per deadlines, and location of the at least one property.

In accordance with an exemplary embodiment, the first report includes new changes identified compared to a previous report, deviations identified compared to a project plan, projected completion date, and remaining construction work of the at least one property.

In accordance with an exemplary embodiment, the second report includes information related to construction materials, dimensions of an interior of the at least one property, shapes of structures, and types of equipment used for construction of the at least one property.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for providing content-based assessments, in accordance with an exemplary embodiment of the present disclosure.

FIG. 2 illustrates an exemplary diagram of a network environment for providing content-based assessments, in accordance with an exemplary embodiment of the present disclosure.

FIG. 3 illustrates an exemplary system for providing content-based assessments, in accordance with an exemplary embodiment of the present disclosure.

FIG. 4 illustrates an exemplary method flow diagram for providing content-based assessments, in accordance with an exemplary embodiment of the present disclosure.

FIG. 5 illustrates an exemplary process flow diagram usable for providing content-based assessments, in accordance with an exemplary embodiment of the present disclosure.

FIG. 6 illustrates a flowchart representing a method for providing content-based assessments, in accordance with an embodiment of the present disclosure.

FIG. 7 illustrates an exemplary process flow for providing property valuation service for loan assessment, in accordance with an embodiment of the present disclosure.

FIG. 8 illustrates an exemplary working of a property valuator model in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for providing content-based financial assessments. Currently, lenders have to rely on an evaluator or agent to perform manual inspection of a property which is a tedious and time-consuming process to evaluate and inspect the property for processing a home loan request. Moreover, such a process may often lead to inaccurate valuation of the property which results in problems such as non-performing assets (NPAs) that caused due to improper loan disbursements (such as home loan disbursements to a borrower) that are based on the evaluator-based inspection process.

Initially, the system receives a request from a user device to initiate the process for at least one property. The system further obtains a plurality of media items captured from a construction site of the at least one property at predefined time intervals, in response to the request. The system further loads the plurality of media items into a trained model to perform analysis on the plurality of media items, the analysis comprises comparing the plurality of media items with a set of input data corresponding to a virtual representation of the at least one property. The trained model generates a construction progress report, a quality report and a final valuation report of the at least one property based on the analysis on the plurality of media items. The system further transmits at least one recommendation related to a loan disbursement value based on the valuation report, to a lender's device to allow a lender to process and complete the request. This way the system provides financial assessments for processing the loan.

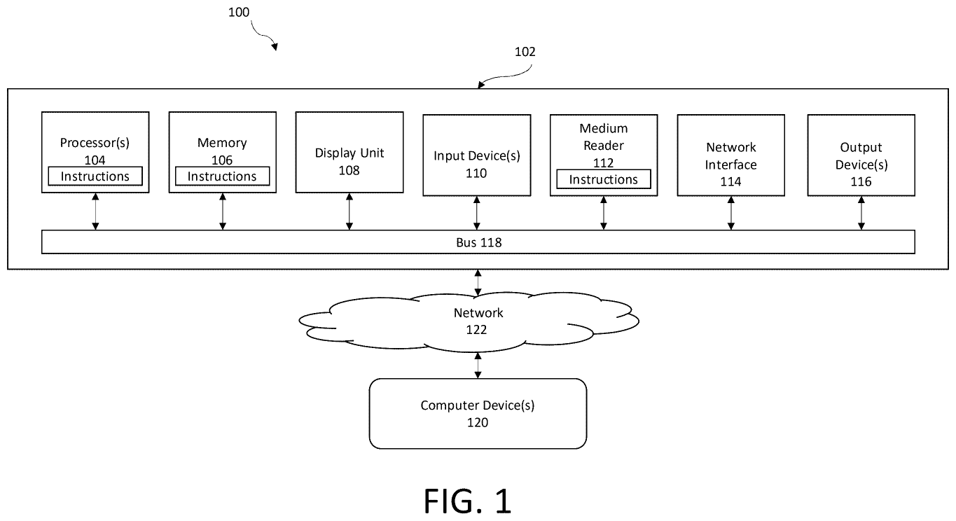

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, and unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for providing content-based financial assessments.

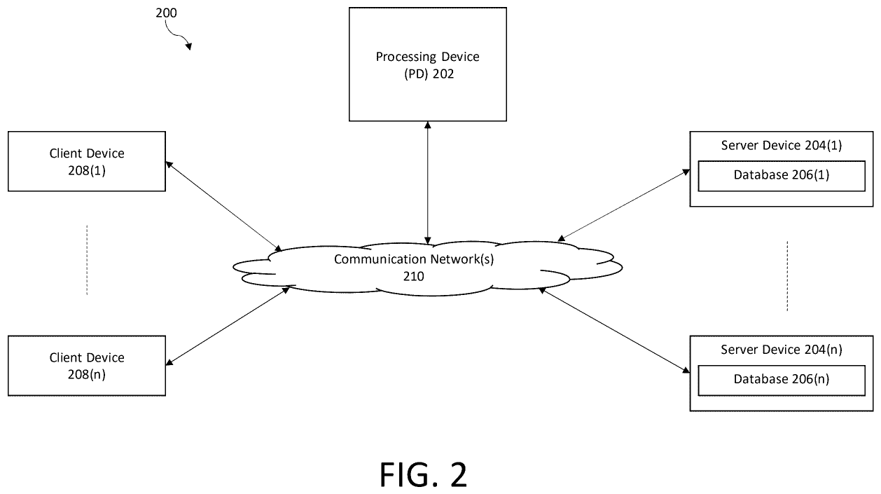

Referring to FIG. 2, a schematic of an exemplary network environment 200 for implementing a method for providing content-based assessments is illustrated. In an exemplary embodiment, the method is executable on any networked computer platform, such as, for example, a personal computer (PC).

The method for providing the content based financial assessments may be implemented by a processing device (PD) 202. The PD 202 may be the same or similar to the computer system 102 as described with respect to FIG. 1. The PD 202 may store one or more applications that can include executable instructions that, when executed by the PD 202, cause the PD 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the PD 202 itself, may be located in the virtual server(s) running in a cloud-based computing environment rather than being tied to one or more specific physical network computing devices. Also, the application(s) may be running in one or more virtual machines (VMs) executing on the PD 202. Additionally, in one or more embodiments of this technology, virtual machine(s) running on the PD 202 may be managed or supervised by a hypervisor.

In the network environment 200 of FIG. 2, the PD 202 is coupled to a plurality of server devices 204(1)-204(n) that hosts a plurality of databases 206(1)-206(n), and also to a plurality of client devices 208(1)-208(n) via communication network(s) 210. A communication interface of the PD 202, such as the network interface 114 of the computer system 102 of FIG. 1, operatively couples and communicates between the PD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and PDs that efficiently implement the method for providing the content-based financial assessments.

By way of example only, the communication network(s) 210 may include local area network(s) (LAN(s)) or wide area network(s) (WAN(s)), and may use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The PD 202 may be a standalone device or integrated with one or more other devices or apparatuses, such as one or more of the server devices 204(1)-204(n), for example. In one particular example, the PD 202 may include or be hosted by one of the server devices 204(1)-204(n), and other arrangements are also possible. Moreover, one or more of the devices of the PD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the PD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data required for implementation of the features of the present disclosure. For instance, data related to at least one recommendation of a disbursement value, a final valuation report, and a first and second report (for example, a construction progress report and a construction quality report).

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the PD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the PD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the PD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PD 202, the server devices 204(1)-204(n), or the client devices 208(1)-208(n), for example, may be configured to operate as virtual instances on the same physical machine.

In other words, one or more of the PD 202, the server devices 204(1)-204(n), or the client devices 208(1)-208(n) may operate on the same physical device rather than as separate devices communicating through communication network(s) 210. Additionally, there may be more or fewer PDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

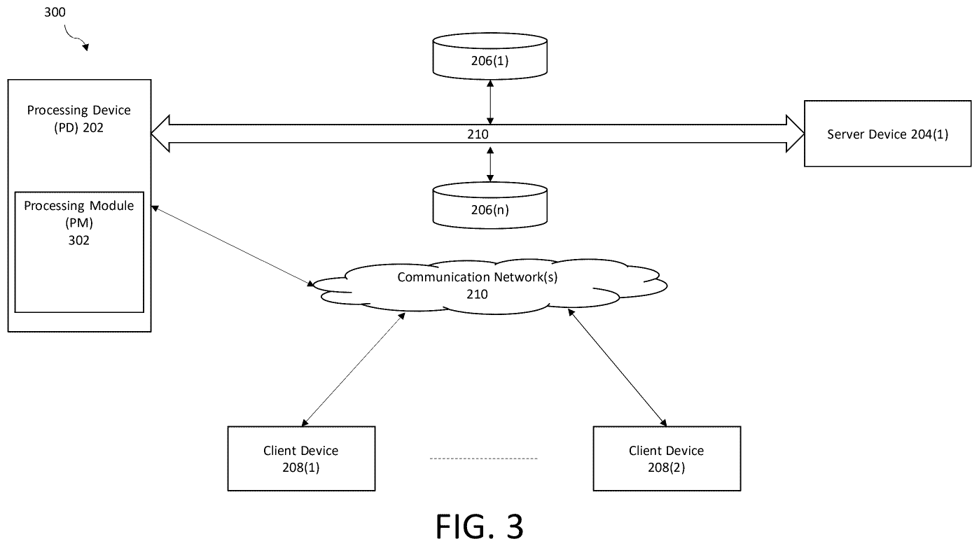

FIG. 3 illustrates an exemplary system for implementing a method for providing content-based assessments, in accordance with an exemplary embodiment. As illustrated in FIG. 3, according to exemplary embodiments, the system 300 may include a processing device (PD) 202 including a processing module (PM) 302 that may be connected to a server device 204(1) and one or more repository from the repositories 206(1) 206(n) via a communication network 210, but the disclosure is not limited thereto.

The PD 202 is described and shown in FIG. 3 as including the PM 302, although it may include other rules, policies, modules, databases, or applications, for example. As will be described below, the PM 302 is configured to implement a method for providing content-based financial assessments.

An exemplary system 300 for implementing a mechanism for providing the content-based financial assessments by utilizing the network environment of FIG. 2 is shown as being executed in FIG. 3. Specifically, a first client device 208(1) and a second client device 208(2) are illustrated as being in communication with the PD 202. In this regard, the first client device 208(1) and the second client device 208(2) may be “clients” of the PD 202 and are described herein as such. Nevertheless, it is to be known and understood that the first client device 208(1) and/or the second client device 208(2) need not necessarily be “clients” of the PD 202, or any entity described in association therewith herein. Any additional or alternative relationship may exist between either or both of the first client device 208(1) and the second client device 208(2) and the PD 202, or no relationship may exist.

Further, the PD 202 is illustrated as being able to access one or more repositories 206(1) . . . 206(n). The PM 302 may be configured to access these repositories/databases for implementing the method for providing the content-based financial assessments.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the PD 202 via broadband or cellular communication. These embodiments are merely exemplary and are not limiting or exhaustive.

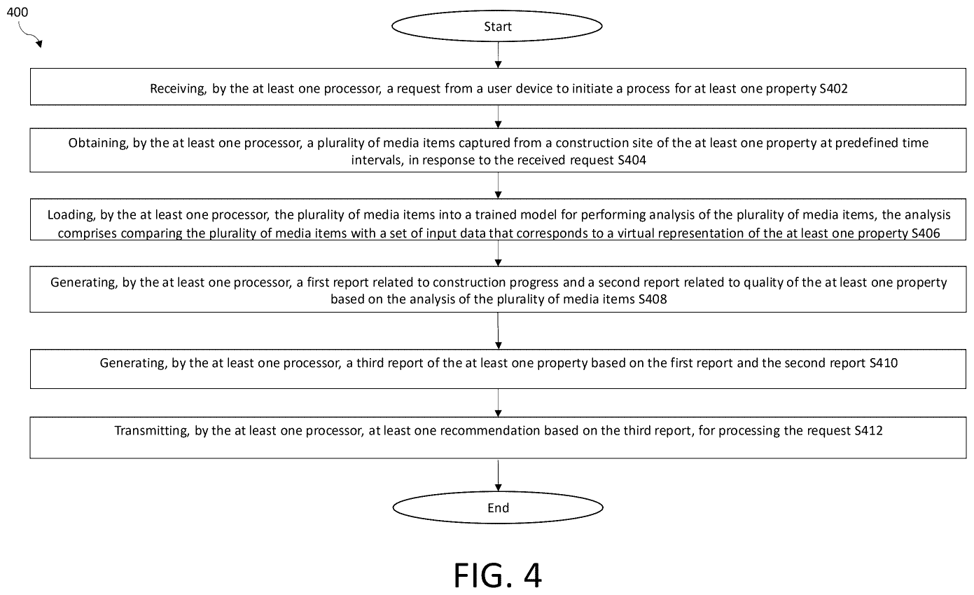

Referring to FIG. 4, an exemplary method 400 is shown for providing content based assessments, in accordance with an exemplary embodiment. In an exemplary implementation, the method 400 may be used for recommending a loan disbursement value of a property (e.g., a home) to an agent of a lender or the lender in order to ease the processing of a loan request (for example, a home loan request).

The term “content” herein may correspond to the visual information or data associated with a property that is being analyzed and manipulated for processing of loan requests.

As shown in FIG. 4, the method 400 begins following a need for processing the loan request for at least one property. The method 400 is implemented by at least one processor 104.

At step S402, the method 400 includes receiving, by the at least one processor 104, a request from a user device to initiate a process for the at least one property (for example, a home). In an exemplary implementation, the process initiated by the user device may be for processing a loan, such as home loan against the property.

The term “property loan” or “home loan” herein may correspond to a type of loan specifically designed by a lender to help users or individuals own a property such as a home.

The term “property” herein may correspond to a physical asset such as land or home for which the user wants the loan from the lender.

The user device is selected from, but not limited to, a personal computer (PC), a tablet computer, a personal digital assistant, a mobile device, a laptop computer, a desktop computer, a wireless smartphone, a wearable device, a web appliance, or any other machine capable of executing a set of instructions (sequential or otherwise) that specify actions to be taken by that machine.

The “request” or “request for the process” may refer to a loan request or a request for processing of a loan, which may include information such as personal details of a borrower or a user (such as a name, an address, and a contact information), financial information (such as income, an employment status, assets, and debts), details about the property being purchased (such as address, a purchase price, a type of the property), and the desired loan amount and terms (such as a loan amount, an interest rate, a repayment period).

In an exemplary implementation, the user may raise the request for the loan (e.g., home loan) via a user interface (UI) of a user platform (e.g., the user platform may be associated with the lender) that is installed on the user's device. In an example, a loan-based application associated with a bank may be used by the user to initiate or send a request for the loan. Further, an agent or an evaluator of the lender (e.g., from a financial institution or the bank) may initiate the loan process using a lender's device in response to the request. For example, the agent or the evaluator of the lender may ask for documents (such as personal details, financial information, details about the property being purchased, etc.) from the user to process the request for the loan. The agent or the evaluator of the lender may use the user interface (UI) rendered on a display unit of the lender's device to upload the documents provided by the user. The UI may be a graphical user interface (GUI). The loan-based platform may be associated with the lender or the financial institution such as a bank. Further, the method initiates the process of the loan upon receiving the inputs and documents from the user.

At step S404, the method includes obtaining, by the at least one processor 104, a plurality of media items captured from a construction site of the at least one property at predefined time intervals, in response to the request.

In an exemplary implementation, upon receiving the request, the UI may display options related to prerequisites to the agent or the evaluator via the UI in order to receive the input from the agent or the evaluator on the prerequisites. The prerequisites may include the plurality of media items, financial information, details about the property being purchased, etc. Further, the agent or evaluator (such as the bank's agent) uploads the plurality of media items captured from the construction site of the at least one property via the UI of the user platform in response to the request. The agent or the evaluator utilizes the lender's device (such as camera-based smart device) for uploading the plurality of media items.

The method includes obtaining, by the at least one processor 104, the plurality of media items at the predefined time intervals. The predefined time intervals may include a first interval and subsequent intervals. Obtaining the plurality of media items at the first interval corresponds to capturing media items at an initial phase of construction of the at least one property. Obtaining the plurality of media items at the subsequent intervals corresponds to capturing media items during a middle or during any other subsequent phase(s) on a progress of construction of the at least one property. For example, the predefined time intervals may be selected from, but are not limited to, weeks, months, quarters, years, or any other combination thereof.

The plurality of media items may include images (for example, images of the property, the area around the property), videos (for example, videos of the property, area around the property) and construction site surroundings around the at least one property. The images and videos of the property may include captured media items of the interior and exterior of the property.

At step S406, the method includes loading, by the at least one processor 104, the plurality of media items into a trained model for performing analysis on the plurality of media items, the analysis includes comparing the plurality of media items with a set of input data corresponding to a virtual representation of the at least one property.

The term “virtual representation” herein may correspond to a digital or computer-generated simulation of a physical living space such as a home or a property. For example, the virtual representation may include 3D models, virtual tours, or interactive experiences of the home or the property.

The set of input data includes a project schedule associated with the construction site, a building information model (for example, 3D models of at least one property), video(s) of surroundings of the construction site of at least one property, a blueprint and a pre-defined construction quality of the at least one property. In an exemplary implementation, the pre-defined construction quality of the at least one property may be an agreed upon quality between the lender and a property builder of the at least one property.

The trained model is developed using machine learning (ML). The trained model may be configured to perform image processing on the plurality of media items to parse or process blueprint(s) of at least one property. The trained model may use convolution neural networks (CNNs) and deep learning algorithms to identify construction progress at the construction site of the at least one property by processing the plurality of media items. In an example, amazon web services (AWS) recognize, amazon web services (AWS) kendra, and/or amazon web services (AWS) Elastic MapReduce (EMR) services may be used to process the plurality of media items for identification of the construction progress at the construction site.

For example, the trained model may identify objects (such as foundation pillars, walls, ceilings, doors, windows, etc.) by performing image processing on the plurality of media items and comparing them with the set of input data such as blueprint(s) of the at least one property.

The analysis on the plurality of media items at the subsequent intervals further includes comparing, by the at least one processor, the plurality of media items captured at the subsequent intervals with the set of input data (e.g., project schedule) to determine a delay in the construction progress of the at least one property and updating, by the at least one processor, the delay in the construction progress of the at least one property.

The term “project schedule” herein may correspond to a timeline for tasks and activities that need to be completed in order to build or construct the at least one property. The project schedule may include, but not limited to, milestones such as laying the foundation, making walls, framing, electrical and plumbing work, insulation, drywall, painting, and finishing touches. Each task mentioned in the project schedule is assigned a specific start and end date to help keep the project on track and ensure it is completed on time.

For example, if the images captured at the construction site of the at least one property at different time intervals (such as on day one of work and after a hundred days of work at the construction site) show deviation in comparison to the project schedule (for example, images for day one should depict foundation work phase and images for day hundred should depict pillar construction phase), then the at least one processor 104 update status of the construction site in response to the identified delay in the project.

The trained model may process the plurality of media items using the artificial intelligence (AI)/machine learning techniques and compute the following parameters as construction progress percentage, surroundings and issues, quality of construction, risk evaluation, the percentage of the amount that may be disbursed, all the properties in the locality to detect fraudulent updates.

At step 408, the method includes generating, by the at least one processor 104, a first report related to a construction progress and a second report related to a construction quality of the at least one property based on the analysis on the plurality of media items.

The first report includes new objects or changes identified compared to a previous valuation, deviations identified compared to a project plan, projected completion date, and remaining construction work of the at least one property. Thus, the first report includes all the details and information necessary to check the construction progress of the at least one property.

The second report includes information related to construction materials, dimensions of an interior of the at least one property, shapes of structures, and types of equipment used for construction of the at least one property. For example, the second report may include information related to materials used in the construction of the property, quality of work, the height of the plinth, the height of the at least one property, thickness of walls, nature of the structure, type of flooring, roof, doors, windows and types of equipment used for construction. Thus, the second report includes all the details and information required to assess the construction quality of the at least one property.

In an exemplary implementation, the method includes generating, by the at least one processor 104, the first report and the second report in a sequential manner.

For example, the construction progress report may be generated based on a comparison of the images captured at the construction site at the subsequent time intervals with the building information model and the project schedule. In case the project schedule mentions that three floors need to be ready within 8 months of the launch of a commercial project but the images obtained in the plurality of media items after the 8 months depict the completion of two floors instead only then the construction progress report may highlight this identified delay (e.g., delay in construction of one floor) in the construction progress report.

At step S410, the method includes generating, by the at least one processor 104, a third report of the at least one property based on the first report and the second report. The third report may include a ratio, quality deviations within allowed thresholds as per design, progress as per deadlines, and location of the at least one property. The third report may include all relevant details related to the property that are necessary to assess the loan and to decide the disbursement of a loan value. In an exemplary implementation, the third report may be a valuation report for the at least one property. The ratio included in the third report may be a loan to value ratio.

At step 412, the method includes transmitting, by the at least one processor 104, at least one recommendation based on the third report, for processing the request. In an exemplary implementation, the recommendation may include a recommended loan disbursement value. Based on a configuration of the lender's device and processing of the request by the lender, the recommended loan disbursement value may be shown to the user either immediately or after the realization of the fund.

The term “loan disbursement value” herein may correspond to an amount of money to be paid out to the borrower by the lender to purchase the at least one property.

For example, the method 400 may include displaying, by the at least one processor 104, the at least one recommendation via the user interface (UI) to the lender's device to further process the request for the loan. The at least one recommendation related to the loan disbursement value may be further sent to the internal loan departments of the lender for performing a manual review of the loan request, the recommended loan disbursement value, and taking a final decision on the loan request raised by the user. In parallel, the lender may also receive input from the user for the required disbursement value for the purchase of the property. In an example, the recommendation is for an amount (X+500) while the user only wants the limited X amount for the purchase of the property.

Thus, based on the user input and recommendation, the lender may process the request and disburse the required disbursement value to the user.

If the lender provides a positive response via the UI to accept the recommended loan disbursement value then the at least one processor 104 may transmit a notification about the successful disbursement of the amount to the user device. In an exemplary implementation, at least one recommendation related to the loan disbursement value may be displayed via the UI of the user device to provide information to the user about the approved loan disbursement value. The user may provide input mentioning the required disbursement value via the UI in response to the received at least one recommendation. For example, the user may ask for a lower amount for the disbursement then the recommended loan disbursement value.

In another exemplary implementation of the present disclosure, if the lender provides a negative response via the UI for the recommended loan disbursement value then the at least one processor 104 causes the UI to display a notification about a rejection of the request for the loan in response to the received request. This way the disclosed method executes the request received for the loan processing.

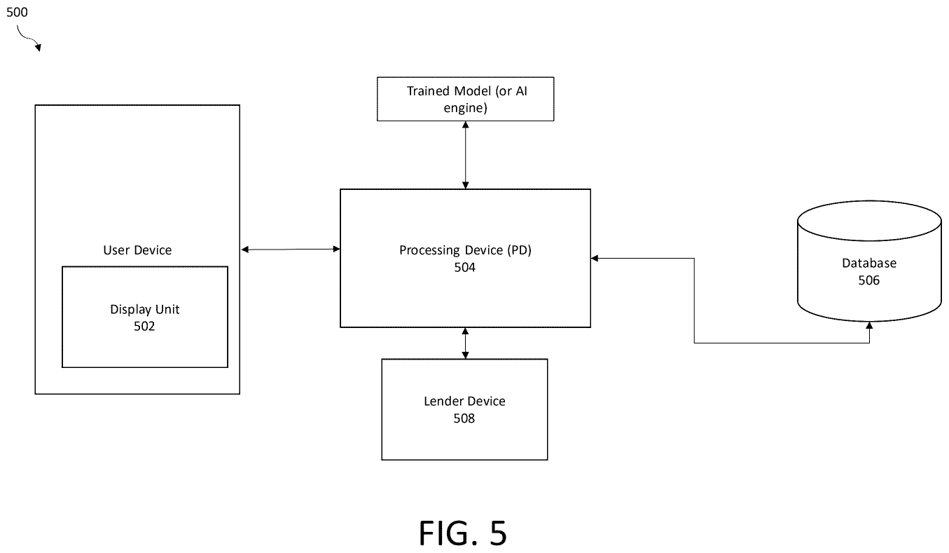

FIG. 5 illustrates an exemplary process flow diagram usable for providing content based assessments, in accordance with an exemplary embodiment. As illustrated in FIG. 5, the process flow 500 begins with receiving, by a processing device (PD) 504, a request from a user device to initiate a process for at least one property. The user device may be employed with a loan-based platform associated with a lender to initiate a request for the loan (for example, a home loan) for the at least one property. The UI is rendered on a display unit 502 of the user's device. In an exemplary implementation, the request may be to initiate a process of a loan for the at least one property.

The user device may be connected with the PD 504 via a network such as an internet-based network. Further, the lender or an agent or an evaluator of the lender may initiate the process of the loan for the received request by using the loan-based platform (e.g., bank-specific application) installed on the processing device 504. Further, the PD 504 may obtain a plurality of media items captured from a construction site of the at least one property at predefined time intervals, in response to the request. The lender or the agent or the evaluator of the lender may capture the plurality of media items from the construction site of the at least one property. The predefined time intervals include a first interval and subsequent intervals.

In an exemplary implementation, the PD 504 may store the plurality of media items to external sources, including, for example, a database 506 or servers of financial institutions.

The PD 504 further loads the plurality of media items into a trained model (e.g., artificial intelligence (AI) engine or machine learning (ML) engine) to perform an analysis on the plurality of media items. The analysis includes a comparison of the plurality of media items with a set of input data corresponding to a virtual representation of the at least one property. The PD 504 further generates a first report related to construction progress and a second report related to a construction quality of the at least one property based on the analysis on the plurality of media items. The PD 504 further generates a third report of the at least one property based on the generated first and second reports. Finally, the PD 504 transmits at least one recommendation to the lender's device 508 to receive a response or feedback on the at least one recommendation from the lender. In an exemplary implementation, the third report may be a valuation report which is generated based on the construction progress and the construction quality of the at least one property. Further, the recommendation may be related to the loan disbursement value. The PD 504 recommends the loan disbursement value based on the valuation report. The PD 504 may store the at least one recommendation, the first and second report, and the valuation report in the external sources such as the database 506. The at least one recommendation along with the valuation report may be transmitted to the lender's device 508 for further review and analysis. For example, the lender may further transmit the request to internal departments to review and process the at least one recommendation and thus take the final decision on the request.

In a first exemplary embodiment, the lender may process the request of the user and may disburse the loan disbursement value to the user based on a positive feedback on the recommendation. For example, if the at least one recommendation is satisfactory as per the predefined loan disbursement standards of the lender, then the lender may process the request related to the loan disbursement value and transmits a notification displaying the approved loan disbursement value to the user device.

In a second exemplary embodiment, the lender may refuse the request of the user and may deny further processing of the request based on a negative feedback on the recommendation. For example, if at least one recommendation is noncompliant as per predefined loan disbursement standards of the lender, then the lender may refuse to process the request related to the loan disbursement value.

In a third exemplary embodiment, the lender may limit the amount of the loan disbursement value in an event the recommendation fails to match at least one loan disbursement criteria of the lender.

It would be appreciated by the person skilled in the art that the PD 504 offers a full-circle, adaptable, and intelligent solution for processing home loan requests.

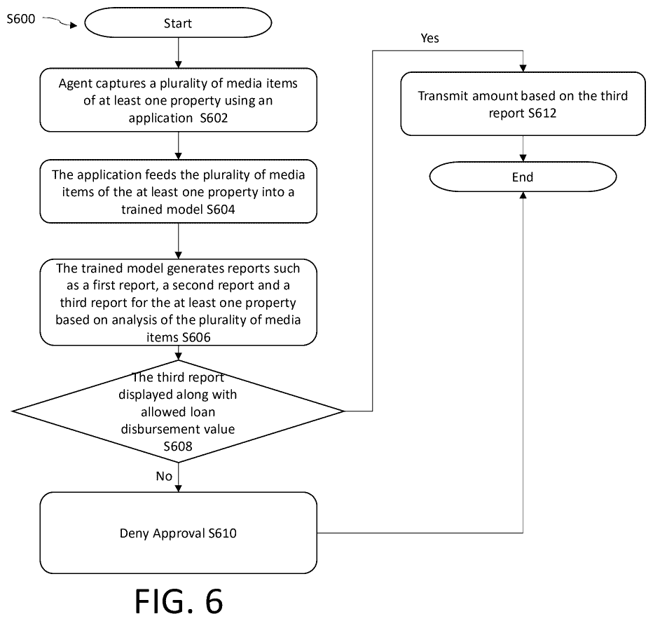

FIG. 6 illustrates an exemplary process flow 600 for providing content-based assessments, in accordance with an embodiment of the present disclosure. As illustrated in FIG. 6, the process flow 600 begins with receiving a request to initiate a process for at least one property via a user interface (UI) of a user platform that may be installed in a user device. In an exemplary implementation, the request may be for processing a loan for the at least one property. A lender or an agent or an evaluator of the lender may operate the lender's device to process the request.

At step S602, the lender or the evaluator or the agent of the lender captures a plurality of media items of the at least one property (for example, a home or a building) using an application (e.g., a user platform associated with the lender) installed in the lender's device. At step S604, the application feeds the plurality of media items of the at least one property to a trained model (e.g., an artificial intelligence (AI) or a machine learning (ML) engine). At step S606, the trained model generates a first report related to construction progress and a second report related a construction quality of the at least one property based on the analysis of the plurality of media items. A third report is generated based on the first report and the second report. In an exemplary implementation, the third report may be a valuation report. At step S608, the valuation report is displayed along with allowed loan disbursement value via the UI of the lender's device to receive a response from the lender.

At step 610, the lender may deny approval for the loan disbursement value after further reviewing the request and terminates the request. At step 612, the application is configured to generate a notification about the successful disbursement of the allowed loan disbursement value in case of receiving a positive response from the lender via the UI of the user platform.

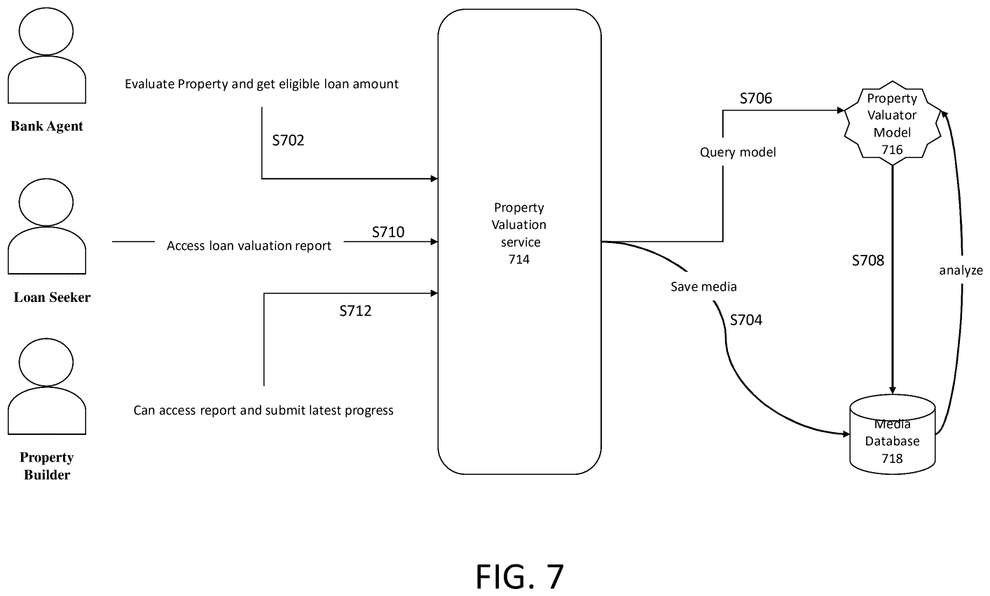

FIG. 7 illustrates an exemplary process flow 700 for providing property valuation service for loan assessment, in accordance with an embodiment of the present disclosure. As illustrated in FIG. 7, the process flow 700 begins with receiving a request from a bank agent to initiate a property valuation and get an assessment for an eligible loan amount for a user. The user may be the person who has bought or has to buy the property from a property builder or a landowner. The request at step S702 is passed from the bank agent to a property valuation service 714. The property valuation service 714 may be similar in functionality provided by the loan processing device (LPD) 504 as described with respect to FIG. 5. The property valuation service 714 may also provide a user interface to display information for the user or a lender or a bank, similar to the lender device 508 as described in FIG. 5. At step S704, images and videos of the property and its location may be uploaded by either the bank agent, the property builder or the user to a media database 718 via the property valuation service 714. The media database 718 may be similar to the database 506 as described with respect to FIG. 5.

At step S706, the property valuation service 714 may query a proprietary inbuilt property valuator model 716. In an exemplary implementation, the property valuator model 716 may be similar to the ‘trained model’ as described in FIG. 4, FIG. 5 and FIG. 6. At step S708, the property valuator model 716 may access the media database 718 for analyzing the images and videos uploaded and based on previous reports it may predict a maximum loan amount that may be granted to the user. The property valuator model 716 may generate a loan valuation report based on analyzing the images and videos of the property and the previous reports. The loan valuation report may include all relevant details related to the property that are necessary to assess the loan and to decide the disbursement of a loan value. The loan valuation report may then be sent to the property valuation service 714 and stored in the media database 718. The loan valuation report may be similar to the ‘third report’ as described in FIG. 4, FIG. 5 and FIG. 6.

At step S710, the user or the loan seeker may access the loan valuation report by sending a request to the property valuation service 714. In an exemplary implementation, the loan valuation report may depict construction progress as per the construction plan. The construction progress may be shown in the range of 0-100%. The loan valuation report may include a quality score as per the construction plan, which may be shown in the range of 0-100%. The loan valuation report may include deviations compared to the construction plan, which may be shown in the range of 0-100%. The loan valuation report may further include an eligible loan amount that may be disbursed based on the construction progress. The loan valuation report may further include changes in layout as compared to the construction plan that was originally submitted by the property builder.

At step S712, the property builder may access the loan valuation reports from time to time to assess if the loan valuation reports show the construction progress correctly and if required may submit latest progress with images and videos.

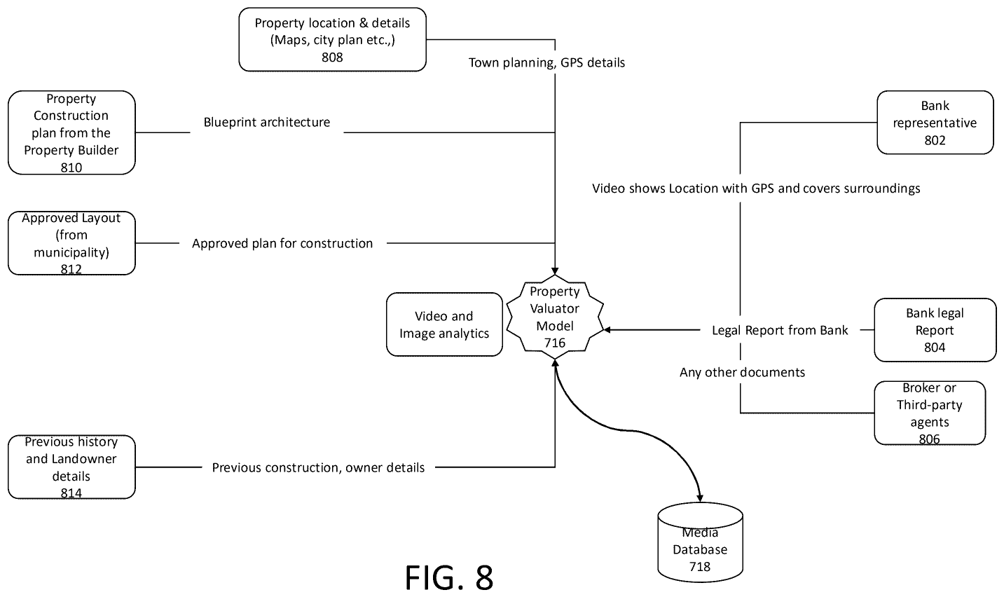

FIG. 8 illustrates an exemplary working of a property valuator model in accordance with an embodiment of the present disclosure. The property valuator model 716 as described here is same as that described above with respect to FIG. 7. Further, the property valuator model 716 may be similar to the ‘trained model’ as described with respect to FIG. 4, FIG. 5 and FIG. 6. As shown in FIG. 8, the property valuator model 716 may be fed with multiple data from various sources. A bank representative 802 or a bank agent may feed images and videos of a property and its location covering surroundings to the property valuator model 716. The bank representative may also upload the bank's legal report 804.

Property brokers or third-party agents 806 may upload any relevant document pertaining to the property. A property builder or a landowner may upload property location and details 808 including maps, city plan, and global positioning system (GPS) details to the property valuator model 716. The property builder may also submit a property construction plan 810 in the form of blueprint architecture, an approved layout 812 from a governing body, such as municipality. The property builder may also feed in detail about any previous constructions or owner details 814 to provide historical data to the property valuator model 716. This historical data may drive the loan decision based on past reports of the property builder. The property valuator model 716 may be trained on different construction videos, images, and locations to identify objects, construction quality and parameters. The data fed into the property valuator model 716 from the above cited sources may be stored in the media database 718 for further analysis.

Further the property valuator model 716 may maintain context i.e. if the property is an under-construction property, it may validate construction progress across different videos/images fed to it during different times. The property valuator model 716 may use video analytics and large language models as well for analyzing the data fed into it from various sources. The property valuator model 716 may generate a property valuation report for a property based on analyzing the data. The property valuation report may include details as described with respect to FIG. 7. Further, the loan valuation report may be similar to the ‘third report’ as described in FIG. 4, FIG. 5 and FIG. 6.

The advantages of the present invention are mentioned as follows. The present invention provides financial assessments for home loan requests. The present invention automates the inspection and evaluation process of a property using the media items of the property. The present invention provides automation of home loan disbursements. The present invention ensures a proper inspection and evaluation of the property.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory.

Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for providing content based financial assessments is disclosed. The instructions include executable code which, when executed by a processor, may cause the processor to receive a request from a user device to initiate a process of a loan for at least one property; obtain a plurality of media items captured from a construction site of the at least one property at predefined time intervals, in response to the request; load the plurality of media items into a trained model to perform an analysis on the plurality of media items, the analysis includes comparison of the plurality of media items with a set of input data corresponding to a virtual representation of the at least one property; generate a first report related to a construction progress and a second report related to the construction quality of the at least one property based on the first and second report; generate a valuation report of the at least one property based on the first report and the second report; and transmit at least one recommendation related to a loan disbursement value based on the valuation report, to a lender's device to process the request.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure.

Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for providing content-based assessments, the method being implemented by at least one processor, the method comprising:
receiving, by the at least one processor, a request from a user device to initiate a process for at least one property;
obtaining, by the at least one processor, a plurality of media items captured from a construction site of the at least one property at predefined time intervals, in response to the request;
loading, by the at least one processor, the plurality of media items into a trained model for performing an analysis on the plurality of media items, the analysis comprises comparing the plurality of media items with a set of input data corresponding to a virtual representation of the at least one property;
generating, by the at least one processor, a first report related to a construction progress and a second report related to a construction quality of the at least one property based on the analysis on the plurality of media items;
generating, by the at least one processor, a third report of the at least one property based on the first report and the second report; and
transmitting, by the at least one processor, at least one recommendation based on the third report, for processing the request.

2. The method as claimed in claim 1, wherein the plurality of media items comprises images, videos, and construction site surroundings of the at least one property.

3. The method as claimed in claim 1, wherein the set of input data comprises a project schedule associated with the construction site of the at least one property, a building information model, video(s) of surroundings of the construction site, a blueprint, and a predefined construction quality of the at least one property.

4. The method as claimed in claim 1, wherein the predefined time intervals comprise a first interval and subsequent intervals.

5. The method as claimed in claim 4, wherein the analysis on the plurality of media items at the subsequent intervals further comprises:
comparing, by the at least one processor, the plurality of media items captured at the subsequent intervals with the set of input data to determine a delay in the construction progress of the at least one property; and
updating, by the at least one processor, the delay in the construction progress of the at least one property in the first report.

6. The method as claimed in claim 1, wherein the trained model is developed using machine learning (ML).

7. The method as claimed in claim 1, wherein the third report comprises a ratio, quality deviations within allowed thresholds as per design, a progress as per deadlines, and a location of the at least one property.

8. The method as claimed in claim 1, wherein the first report comprises new changes identified compared to a previous report, deviations identified compared to a project plan, a projected completion date, and remaining construction work of the at least one property.

9. The method as claimed in claim 1, wherein the second report comprises information related to construction materials, dimensions of an interior of the at least one property, shapes of structures, and types of equipment used for construction.

10. A computing device configured to implement an execution of a method for providing content-based assessments, the computing device comprising:
a processor;
a memory; and
a communication interface coupled to each of the processor and the memory,
wherein the processor is configured to:
receive a request from a user device to initiate a process for at least one property;
obtain a plurality of media items captured from a construction site of the at least one property at predefined time intervals, in response to the request;
load the plurality of media items into a trained model to perform an analysis on the plurality of media items, the analysis comprises comparing the plurality of media items with a set of input data corresponding to a virtual representation of the at least one property;
generate a first report related to a construction progress and a second report related to a construction quality of the at least one property based on the analysis on the plurality of media items;
generate a third report of the at least one property based on the first report and the second report; and
transmit at least one recommendation based on the third report, for processing the request.

11. The computing device as claimed in claim 10, wherein the plurality of media items comprises images, videos, and construction site surroundings of the at least one property.

12. The computing device as claimed in claim 10, wherein the set of input data comprises a project schedule associated with the construction site of the at least one property, a building information model, video(s) of surroundings of the construction site, a blueprint and a predefined construction quality of the at least one property.

13. The computing device as claimed in claim 10, wherein the predefined time intervals comprise a first interval and subsequent intervals.

14. The computing device as claimed in claim 13, wherein to analyse the plurality of media items at the subsequent intervals, the processor is further configured to:
compare the plurality of media items captured at the subsequent intervals with the set of input data to determine a delay in the construction progress of the at least one property; and
update the delay in the construction progress of the at least one property in the first report.

15. The computing device as claimed in claim 10, wherein the trained model is developed using machine learning (ML).

16. The computing device as claimed in claim 10, wherein the third report comprises a ratio, quality deviations within allowed thresholds as per design, a progress as per deadlines, and a location of the at least one property.

17. The computing device as claimed in claim 10, wherein the first report comprises new changes identified compared to a previous report, deviations identified compared to a project plan, a projected completion date, and remaining construction work of the at least one property.

18. The computing device as claimed in claim 10, wherein the second report comprises information related to construction materials, dimensions of an interior of the at least one property, shapes of structures, and types of equipment used for construction.

19. A non-transitory computer readable storage medium storing instruction for providing content-based assessments, the instructions comprising executable code which when executed by a processor, causes the processor to perform operations comprising:
receiving, by the at least one processor, a request from a user device to initiate a process for at least one property;
obtaining, by the at least one processor, a plurality of media items captured from a construction site of the at least one property at predefined time intervals, in response to the request;
loading, by the at least one processor, the plurality of media items into a trained model for performing an analysis on the plurality of media items, the analysis comprises comparing the plurality of media items with a set of input data corresponding to a virtual representation of the at least one property;
generating, by the at least one processor, a first report related to a construction progress and a second report related to a construction quality of the at least one property based on the analysis on the plurality of media items;
generating, by the at least one processor, a third report of the at least one property based on the first report and the second report; and
transmitting, by the at least one processor, at least one recommendation based on the third report, for processing the request.

20. The non-transitory computer readable storage medium as claimed in claim 19, wherein the set of input data comprises a project schedule associated with the construction site of the at least one property, a building information model, video(s) of surroundings of the construction site, a blueprint, and a predefined construction quality of the at least one property.
